(19) United States
(12) Patent Application Publication
(10) Pub. No.: US 2022/0065728 A1
(43) Pub. Date: Mar. 3, 2022

(54) ACOUSTIC RESONANCE DIAGNOSTIC METHOD FOR DETECTING STRUCTURAL DEGRADATION AND SYSTEM APPLYING THE SAME

(71) Applicant: INDUSTRIAL TECHNOLOGY RESEARCH INSTITUTE, Hsinchu (TW)

(72) Inventors: Hung-Chih CHANG, Hsinchu City (TW); Yao-Long TSAI, Kaohsiung City (TW); Li-Hua WANG, Hsinchu City (TW)

(73) Assignee: INDUSTRIAL TECHNOLOGY RESEARCH INSTITUTE, Hsinchu (TW)

(21) Appl. No.: 17/405,423

(22) Filed: Aug. 18, 2021

Related U.S. Application Data
(60) Provisional application No. 63/071,382, filed on Aug. 28, 2020.

(30) Foreign Application Priority Data
Jun. 8, 2021 (TW) 110120800

(51) Int. Cl. G01M 3/24; G06N 3/04; G01S 19/01

(52) U.S. Cl. CPC G01M 3/243; G01S 19/01; G06N 3/04

(57) ABSTRACT

An acoustic resonance diagnostic method for detecting structural degradation is provided. The method includes steps as follows: Firstly, a training model is built using a deep neural network. At least two training acoustic signals are inputted to the training model to carry a training. A diagnostic model is built according to a result of the training using a convolutional neural network. An under-test sound wave signal is captured from an under-test section of an under-test structure through direct contact, non-contact, or indirect contact. A structural degradation state of the under-test section is determined according to the under-test sound wave signal through the diagnostic model.

This application claims the benefit of U.S. provisional application Ser. No. 63/071,382, filed Aug. 28, 2020, and Taiwan Application No. 110120800, filed on Jun. 8, 2021, the disclosure of which is incorporated by reference herein in its entirety.

### TECHNICAL FIELD

The disclosure relates in general to a method for detecting structural degradation and system, and more particularly to a method for detecting structural degradation using acoustic resonance diagnostic technology and a system applying the same.

### BACKGROUND

Over the years, there have been several accidents related to industrial structures or pipelines. When the industrial structures or pipelines degenerate or leak due to abnormality, severe disasters will occur and end up with casualties and property loss. The abnormality of industrial structures or pipelines are caused mainly by human factors and secondly by the degeneration of the material of industrial structures, pipes or equipment. To avoid the occurrence of disasters, it is essential to monitor the degeneration or leakage of industrial structures or pipelines.

Although the industries have developed several systems and technologies for monitoring industrial structures or pipelines, there still exist many accompanying problems to be resolved. For example, the safety diagnostic module lacks suitable logic judgement, and therefore needs to be evaluated by professionals; the current technology can only suitable for inspection and monitoring of the local degeneration at which the sensor is located and cannot sense the degeneration at a remote end; the current technology cannot emit a warning signal before degeneration occurs; the current technology relies on the inspectors walking to the site to listen to the acoustic change of the pipe.

Therefore, it has become a prominent task for the industries to provide an advanced acoustic resonance diagnostic method for detecting structural degradation and system.

### SUMMARY

According to one embodiment, an acoustic resonance diagnostic method for detecting structural degradation is provided. The method includes steps as follows: Firstly, a training model is built using a deep neural network. At least two training acoustic signals are inputted to the training model to carry a training. A diagnostic model is built according to a result of the training using a convolutional neural network. An under-test sound wave signal is captured from an under-test section of an under-test structure through direct contact, non-contact, or indirect contact. A structural degradation state of the under-test section is determined according to the under-test sound wave signal through the diagnostic model.

According to another embodiment, an acoustic resonance diagnostic system for detecting structural degradation is provided. The system includes: a sound wave sensing unit, an acoustic resonance diagnostic module, and a communication module used to signal-connect the sound wave sensing unit and the acoustic resonance diagnostic module. The sound wave sensing unit is used to capture an under-test sound wave signal from an under-test section of an under-test structure. The acoustic resonance diagnostic module is used to perform the following steps. Firstly, a training model is built using a deep neural network. Then, at least two training acoustic signals are inputted to the training model to carry a training. A diagnostic model is built according to a result of the training using a convolutional neural network. Then, a structural degradation state of the under-test section is determined according to the under-test sound wave signal through the diagnostic model.

As disclosed in above embodiments, the present disclosure provides an acoustic resonance diagnostic system and an acoustic resonance diagnostic method for detecting structural degradation capable of real-timely and remotely detecting the degradation state of an under-test structure (such as, pipe thinning and leakage) using a sound wave signal through contact or non-contact. The dynamic audio capturing module remotely captures the acoustic vibration generated by the under-test structure (such as, the pipe wall), senses the change in the hardness and quality of the under-test structure, and integrates the acoustic vibration to the acoustic resonance diagnostic module through the internet of things (IoT) technology and the cloud computing to build a diagnostic model using a deep learning algorithm, and further synchronically performs leakage recognition, leakage diagnosis and leakage positioning on the under-test sound wave signal to remotely monitor the degradation state.

Furthermore, the acoustic resonance diagnostic module is communication-connected to a plurality of hand-held devices or backend platforms, such that different users can real-timely get a real-time information of the under-test structure (pipe) to help the on-site leakage inspectors interpreting the state of the under-test structure (pipe) more effectively t and provide a prompt inspection to assure the operation safety of the under-test structure (pipe).

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1 is a configuration diagram of an acoustic resonance diagnostic system for detecting structural degradation according to an embodiment of the present disclosure;

FIG. 2 is a spectrogram obtained by filtering the sound wave signal captured by a sound wave sensing unit using a filter according to an embodiment of the present disclosure;

FIG. 3 is a flowchart of an acoustic resonance diagnostic method using the acoustic resonance diagnostic system as depicted in FIG. 1 to detect structural degradation according to an embodiment of the present disclosure;

FIG. 4 is a block diagram of a deep autoencoder according to an embodiment of the present disclosure;

FIG. 5 is a schematic diagram of a frequency band of an under-test sound wave signal in a leakage state according to an embodiment of the present disclosure;

FIG. 6 is a graph of several amplitude vs position (length) curves of the under-test sections with identical structural degradation (leakage) feature but different feature positions, that are stored in a database, according to an embodiment of the present disclosure; and

FIG. 7 is a graph of several amplitude vs position (length) curves corresponding to specific characteristic frequencies in a database according to an embodiment of the present disclosure.

### DETAILED DESCRIPTION

The present disclosure provides an acoustic resonance diagnostic method for detecting structural degradation and a disclosed applying the same capable of sensing structural degradation at a remote end and enabling the on-site leakage inspectors to effectively interpret the state of an under-test structure and provide a prompt inspection. For the object, technical features and advantages of the present disclosure to be more easily understood by anyone ordinary skilled in the technology field, a number of exemplary embodiments are disclosed below with detailed descriptions and accompanying drawings.

It should be noted that these embodiments are for exemplary and explanatory purposes only, not for limiting the scope of protection of the invention. The invention can be implemented by using other features, elements, methods and parameters. The preferred embodiments are merely for illustrating the technical features, not for limiting the scope of protection. Anyone skilled in the technology field of the invention will be able to make suitable modifications or changes based on the specification disclosed below without breaching the spirit of the invention. The identical elements of the embodiments are designated with the same reference numerals.

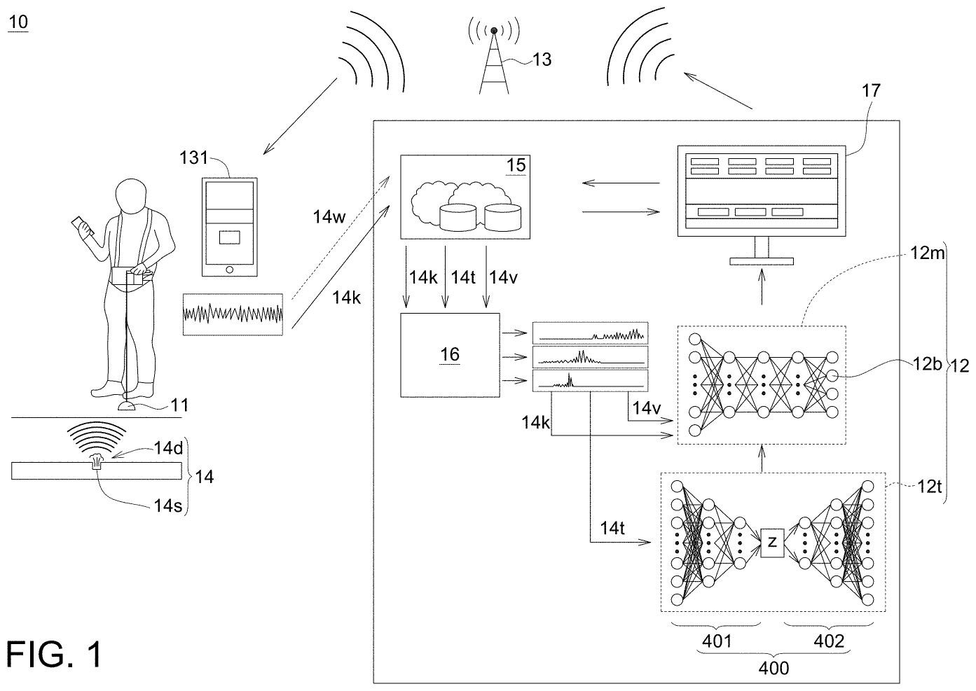

Referring to FIG. 1, a configuration diagram of an acoustic resonance diagnostic system 10 for detecting structural degradation according to an embodiment of the present disclosure is shown. The acoustic resonance diagnostic system for detecting structural degradation 10 includes a sound wave sensing unit 11, an acoustic resonance diagnostic module 12, and a communication module 13 used to signal-connect the sound wave sensing unit 11 to the acoustic resonance diagnostic module 12.

The sound wave sensing unit 11 is used to capture an under-test sound wave signal 14k from an under-test section 14s of an under-test structure 14. In some embodiments of the present disclosure, the under-test structure 14 can be realized by (but is not limited to) a pipe structure, such as oil pipe, water pipe or other pipe structure for transporting liquid or gas. The under-test structure 14 can be realized by a solid structure, such as floor structure, road filling structure, steel-bone structure, or other structure capable of generating an acoustic signal through acoustic resonance. In one embodiment, the sound wave sensing unit 11 can capture an under-test sound wave signal 14k from the under-test section 14s of the under-test structure 14 through non-contact or from a distance. In one embodiment, the sound wave sensing unit 11 can capture an under-test sound wave signal 14k from the under-test section 14s of the under-test structure 14 through direct contact or indirect contact.

In one embodiment of the present disclosure, the sound wave sensing unit 11 can be realized by (but is not limited to) a portable high-sensitivity piezoelectric sensor, with which the leakage inspectors can detect different positions of the under-test structure 14 (pipe structure) to capture the under-test sound wave signal 14k from the under-test structure 14 (pipe structure). In the present embodiment, the under-test sound wave signal 14k can be realized by (but is not limited to) a time waveform.

The sound wave sensing unit 11 does not directly contact the under-test structure 14 (pipe structure) but is separated from the under-test structure 14 (pipe structure) by a distance, that is, the sound wave sensing unit 11 does not contact the under-test structure 14. In one embodiment, the sound wave sensing unit 11 measures the under-test structure 14 through direct contact or indirect contact. In another embodiment of the present disclosure, the sound wave sensing unit 11 can be realized by (but is not limited to) several acoustic sensors directly fixed at different positions or sections of the under-test structure 14 (pipe structure). The sound wave sensing unit 11 further includes a global positioning system (GPS) for positioning the captured under-test sound wave signal 14k and further transmitting the captured under-test sound wave signal 14k to the acoustic resonance diagnostic module 12 or the control center through wired or wireless communication of the communication module 13 to be stored in the database 15.

The acoustic resonance diagnostic system 10 for detecting structural degradation further includes a signal filter 16 used to perform a filtering step to obtain a frequency band from each sound wave signal of the under-test structure 14 (pipe structure). In one embodiment of the present disclosure, the filtering step performed by the signal filter 16 includes: performing a time domain to frequency domain conversion to convert the time waveform of each sound wave signal into a frequency-domain waveform; capturing a part of the frequency band of the frequency-domain waveform for the acoustic resonance diagnostic module 12 to perform an acoustic resonance diagnosis. In some embodiments of the present disclosure, the frequency band used for acoustic resonance diagnosis is substantially between 10 Hz˜1,800 Hz and preferably is between 30 Hz˜1,600 Hz. The signal filter 16 performs a time domain to frequency domain conversion which converts the original time waveform of the sound wave signal 14w into a frequency-domain waveform. Then, the signal filter 16 captures a part of the frequency-domain waveform and makes the filtered sound wave signal 14w have a frequency band between 200 Hz˜700 Hz.

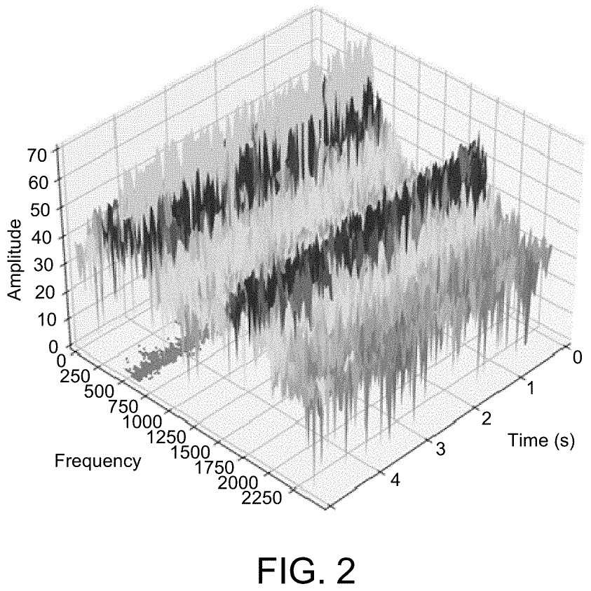

In one embodiment of the present, the filtering step includes subsequently performing a discrete square wave fast Fourier transform (FFT) and a Mel frequency cepstrum (MFC) analysis on the sound wave signal captured by the sound wave sensing unit 11 by the filter 16. For example, the number of filters (signal filter 16) is 30, the Mel frequency cepstrum coefficient (MFCC) is 20 dimensions, the frequency band is between 0 Hz˜44,100 Hz, the Fourier transform has 2,048 points, the size of the audio frame used in the audio file is 5 seconds (s). To avoid dramatic change between the audio frames, every two audio frames overlap by 20 milliseconds (ms). The three axes of the spectrogram 200 as depicted in FIG. 2 respectively are amplitude, frequency and time.

FIG. 2 is obtained as follows. After the signal is filtered by the signal filter 16, the filtered signal can further be divided into 5 frequency bands according to the time axis (second), and each frequency band is further equally divided into 2,000 segments, and the frequencies and amplitudes of each segment are converted into two-dimensional vectors to form a 5 (time)×2,000 (frequency and amplitude) matrix. The above step is repeatedly performed on the signal data obtained through on-site inspection, and each time the measured sound wave signal is converted into an item of matrix data. At the end, about 430,000 items of 5×2,000 matrix data can be obtained. Then, the 430,000 items of 5×2,000 matrix data are stored in the database 15 according to the time sequence and are used as training data (serving as the training acoustic signal 14t and the verification sound wave signal 14v) to carry a training to establish the acoustic resonance diagnostic module 12.

Besides, each sound wave signal 14w must firstly be normalized before the data of the sound wave signal 14w can be trained using a deep learning algorithm. In the present embodiment, the normalization method can be such as min-max normalization. At a particular time point n, the readings obtained through 13 times of sampling form a 13×1 vector (or one-dimensional array) x[n]∈R^{13×1}. The maximum and minimum of each reading respectively form 13×1 vectors xₘᵢₙ[n]∈R^{13×1} and xₘₐₓ[n]∈R^{13×1}. The vector x[n] is normalized according to formula (1):

$${x}_{n o r m} [ n ] = \frac{x [ n ] - {x}_{min} [ n ]}{{x}_{max} [ n ] - {x}_{min} [ n ]} . \qquad ( 1 )$$

The normalized reading xₙₒᵣₘ[n−1] obtained at the previous time point is subtracted from the reading xₙₒᵣₘ[n] obtained at the current time point, using difference methods (DM), which can be expressed as formula (2):

x_{diff}[n]=|xₙₒᵣₘ[n]−xₙₒᵣₘ[n−1]|∈R^{13×1} (2)

wherein, x_{diff} is a difference signal.

Next, the sum of the difference signal x_{diff} is calculated, and a threshold value is set, which can be expressed as formula (3):

$${\sum }_{n = 2}^{16} {{{x}_{diff} [ n ]}^{T} [ \begin{matrix}1 & 1 & … & 1\end{matrix} ]}^{T} > threshold \qquad ( 3 )$$

If the sum of the difference signal is greater than the threshold value threshold, it can be determined that the inputted sound wave signal 14w is a transient signal whose waveform changes dramatically; otherwise, it can be determined that the inputted sound wave signal 14w is a steady signal whose waveform is stable and gentle. The normalized sound wave signal 14w includes a normalized training acoustic signal 14t and a verification sound wave signal 14v, which can represent a transient signal and a steady signal respectively.

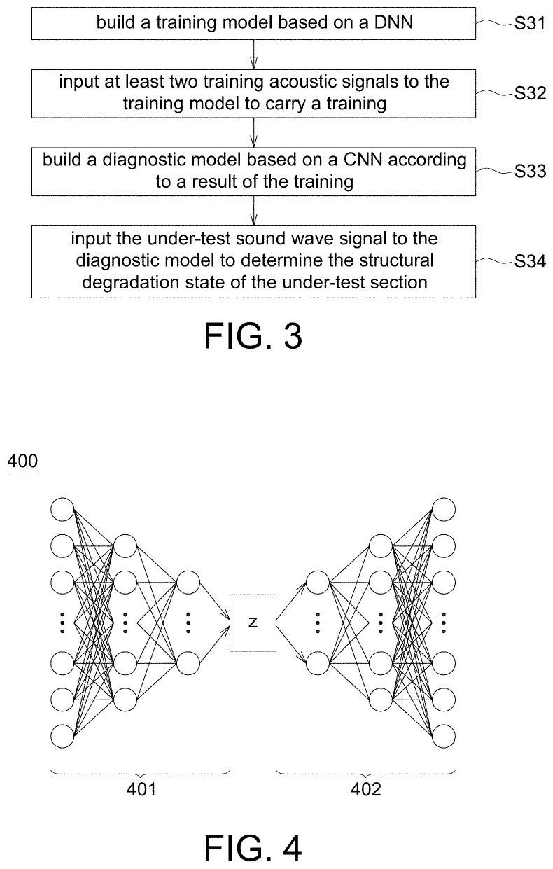

The acoustic resonance diagnostic module 12 is used to perform an acoustic resonance diagnostic method for detecting structural degradation. FIG. 3 is a flowchart of an acoustic resonance diagnostic method using the acoustic resonance diagnostic system 10 as depicted in FIG. 1 to detect structural degradation according to an embodiment of the present disclosure. The acoustic resonance diagnostic method includes steps as follows: Firstly, a training model 12t based on a deep neural network (DNN) is built through unsupervised learning (step S31). Then, at least two training acoustic signals 14t (stored in the database 15) are inputted to the training model 12t to carry a training (step S32) (the normalized sound wave signal 14w includes a normalized training acoustic signal 14t and a verification sound wave signal 14v). Then, a diagnostic model 12m based on a convolutional neural network (CNN) is built according to a result of the training (step S33). Then, the under-test sound wave signal 14k is inputted to the diagnostic model 12m to determine the structural degradation state of the under-test section 14s (step S34).

To put it in greater details, the training model 12t of the acoustic resonance diagnostic module 12 may include a deep autoencoder 400 based on a deep convolutional network. FIG. 4 is a block diagram illustrating the deep autoencoder 400 according to an embodiment of the present disclosure. The structure of the deep autoencoder 400 can be divided into an encoder 401 and a decoder 402, which are respectively used to compress and decompress the training acoustic signal 14t. In the present embodiment, the deep autoencoder 400 is built based on multiple full-connection layers, the encoder 401 has the maximum number of Input neurons on the inputting layer, and the number of neurons on the hidden layers of the encoder 401 diminishes layer by layer. Features of the original training acoustic signal 14t can be extracted through linear transformation or highly nonlinear transformation or the dimensionality reduction of the data.

The decoder 402 decompresses the output code of the encoder 401 to restore the inputted data. In other words, the input data and the output data of the deep autoencoder 400 would be the same. In the present embodiment, since the full-connection layers only accept the input of one-dimensional array, thus the sound wave signal 14w with a 5×2,000 input matrix, prior to being inputted to the deep autoencoder 400, should be flattened as 10,000 one-dimensional arrays. For example, the number of neurons on each layer of the encoder 401 diminishes from 10,000 to 5,000 and 2,500. The encoder 401 has three continuous full-connection layers. The decoder 402 has three continuous full-connection layers, respectively having 2,500, 5,000 and 10,000 neurons. At last, 10,000 values are outputted.

The training of the acoustic resonance diagnostic module 12 includes the following steps: Firstly, 80% of the sound wave signal 14w stored in the database 15 (for example, the data of the sound wave signal 14w that are classified as steady data and obtained according to formulas (2) and (3)) are selected and inputted into the deep autoencoder 400 of the training model 12t for extracting feature values through the encoder 401, whereby a plurality of representative features Z can be extracted from the original training acoustic signal 14t and several feature labels 12b are pre-selected. Through adjustment, it can be verified that the steady data having been treated with a compression process and a decompression process of the deep autoencoder 400 still possess excellent restoration performances. In the present embodiment, through the feature-extraction performed by the deep autoencoder 400, the training acoustic signal 14t basically can be classified into four feature labels 12b, namely, leakage frequency, mental frequency, ambient frequency (environmental frequency) and noise frequency.

Afterwards, a diagnostic model 12m including a convolutional autoencoder is built according to the feature labels 12b of the training model 12t using a convolutional neural network. The remaining 20% of the sound wave signal 14w (for example, the remaining data of the sound wave signal 14w that are classified as transient data and obtained according to formulas (2) and (3)) are inputted to the convolutional autoencoder of the diagnostic model 12m and used as verification data (also called as the verification sound wave signal 14v) to test whether the diagnostic model 12m can successfully detect the transient state. The criterion for determining the transient state is whether the error between the signal restored by the convolutional autoencoder of the diagnostic model 12m and the original signal is over a predetermined threshold value (the signal to noise ratio: 500). If so, the inputted training data are determined as transient data. In the present embodiment, the algorithms used by the convolutional autoencoder include the k-means clustering algorithm.

The output result of the diagnostic model 12m is compared with the verification data, and the weights and the number of feature labels 12b of the diagnostic model 12m are adjusted to complete the training of the acoustic resonance diagnostic module 12. After the training is completed, the sum of the feature values of the feature labels 12b of the diagnostic model 12m is equivalent to 1. In the present embodiment, the 4 feature labels respectively are: leakage frequency, mental frequency, ambient frequency and noise frequency.

After the training of the acoustic resonance diagnostic module 12 is completed, the under-test sound wave signal 14k is inputted to the diagnostic model 12m of the acoustic resonance diagnostic module 12, and the pipe structure and the current structure state of the under-test section 14s of the under-test structure 14 (pipe structure) from which the under-test sound wave signal 14k is captured can be determined according to the feature value outputted by each of the feature labels 12b of the diagnostic model 12m.

In some embodiments of the present disclosure, when the diagnostic model 12m determines that the under-test section 14s of the under-test structure 14 (pipe structures) from which the under-test sound wave signal 14k is captured leaks, the acoustic resonance diagnostic module 12 can further compare the frequency band of the under-test sound wave signal 14k with the historical data of several sound wave signals with identical pipe structures but different leakage features in terms of acoustic frequency offset and amplitude variation, wherein the historical data are stored in the database 15. Thus, relative position of the structural degradation feature 14d in the under-test section 14s of the under-test structure 14 (pipe structure) can be recognized, and the degeneration of the structural degradation feature 14d can be estimated.

The communication module 13 can be realized by a wired or wireless communication device used to signal-connect the sound wave sensing unit 11 to the acoustic resonance diagnostic module 12 for transmitting the sound wave signal captured by the sound wave sensing unit 11 to the acoustic resonance diagnostic module 12 for determination.

In some embodiments of the present disclosure, the communication module 13 may further include a plurality of hand-held devices 131, respectively held by the on-site leakage inspectors or the experts at a remote end. The communication module 13 can transmit the sound wave signal (for example, the training acoustic signal 14t and/or the under-test sound wave signal 14k) captured by the sound wave sensing unit 11 and/or the result determined by the acoustic resonance diagnostic module 12 (for example, the probability of outputting the label 12b) to the on-site leakage inspectors or the experts at the remote end for their reference. Since different users can real-timely get the current state of the under-test structure, the performance of on-site inspection can be effectively improved and the operation safety of the under-test structure 14 (pipe structure) can be assured.

Meanwhile, through the hand-held device 131 of the communication module 13, the on-site leakage inspectors and the experts at the remote end can provide correction advice or instruction to the acoustic resonance diagnostic module 12 to correct or update the diagnostic model 12m of the acoustic resonance diagnostic module 12 according to their individual authority.

In some embodiments of the present disclosure, the acoustic resonance diagnostic system for detecting structural degradation 10 further includes a human-machine interface 17 for integrating the operation procedures of the sound wave sensing unit 11, the acoustic resonance diagnostic module 12 and the communication module 13 as an integrated monitoring management clouds platform. In the present embodiment, the communication module 13 can transmit the diagnosis result obtained by the acoustic resonance diagnostic module 12, the sound wave signal (for example, the frequency tracing graph and the spectrogram) captured by the sound wave sensing unit 11, the inspection position of the sound wave sensing unit 11 and the marking of leakage point on the map to be directly displayed on the user's computer in the form of graphs through a graphical user interface (GUI).

In some embodiments of the present disclosure, when the under-test section 14s is determined to be in a leakage state, the historical data of several sound wave signals with identical pipe structure but different structural degradation (leakage) features 14d can be compared to generate a frequency tracing graph, a spectrogram, and a category diagnostic result, and the position of the structural degradation (leakage) feature 14d in the under-test section 14s can be marked. The historical data are stored in the database 15.

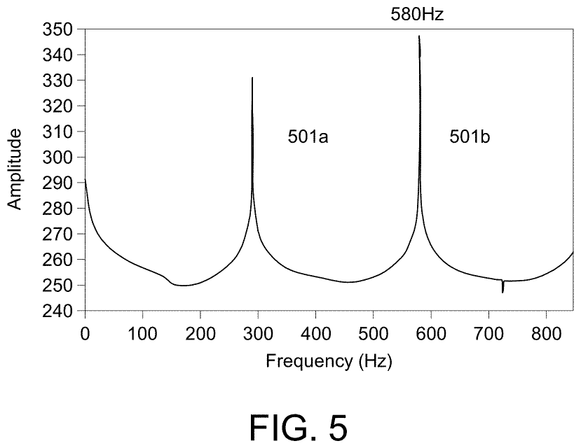

When the under-test section 14s is determined to be in a leakage state, the frequency band of the under-test sound wave signal 14k having been processed with the time domain to frequency domain conversion will have at least one characteristic frequency (peak). Referring to FIG. 5, a schematic diagram of frequency band of an under-test sound wave signal 14k in a leakage state according to an embodiment of the present disclosure is shown. In the present embodiment, the under-test section 14s is determined as a metal tube in a leakage state according to the label value outputted from the feature label 12b of the diagnostic model 12m, and the frequency band of the under-test sound wave signal 14k respectively generates characteristic frequencies 501a and 501b at frequencies 290 Hz and 580 Hz.

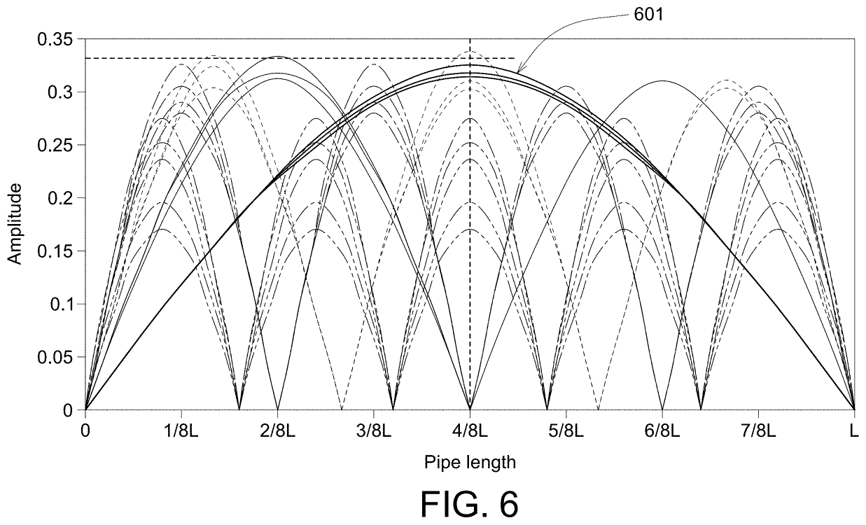

Then, the characteristic amplitude values of the characteristic frequencies 501a and 501b and their characteristic frequencies are compared with a plurality of amplitude vs position (length) curves of the under-test sections 14s with identical structural degradation (leakage) feature 14d but different feature positions obtained from different under-test sections 14s, that are stored in a database 15, to determine the position of the structural degradation (leakage) feature 14d in the under-test section 14s. FIG. 6 is a graph of several amplitude (dB) vs position (length) curves of the under-test sections 14s with identical structural degradation (leakage) feature 14d but different feature positions, that are stored in the database 15, according to an embodiment of the present disclosure.

In the present embodiment, an amplitude (mdB) vs position (length, meter) curve 601 can be obtained from the database 15 according to the characteristic frequencies 501a and 501b. The amplitude vs position (length) curve 601 represents an amplitude vs position (length) curve corresponding to the frequency of 580 Hz. Then, since the crest position of the curve 601 converted according to the characteristic amplitude value 340 dB of the characteristic frequency 501b is close to the crest position at 4/8 L of the pipe length, relative position of the structural degradation (leakage) feature 14d can be marked as 4/8 L of the pipe length of the under-test section 14s.

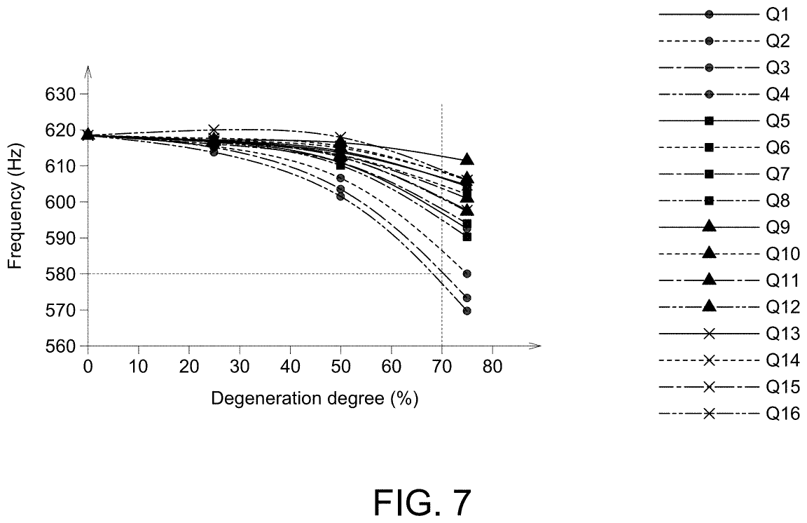

According to the characteristic amplitude values of the characteristic frequencies 501a and 501b, a plurality of amplitude vs degeneration curves 601 corresponding to specific characteristic frequencies in a database 15 can be compared to estimate the degeneration degree of the structural degradation (leakage) feature 14d. Referring to FIG. 7, a graph of several amplitude vs position (length) curves corresponding to specific characteristic frequencies, that are stored in the database 15, according to an embodiment of the present disclosure is shown. The curves Q1 to Q16 respectively represent the amplitude vs degeneration relationship of different defect sizes. For example, for the intersection between the horizontal dotted line and the vertical dotted lines of FIG. 7, it can be estimated according to the sum of the characteristic frequency 302 (580 Hz) that the current structural degradation (leakage) feature 14d of the under-test section 14s has a degeneration degree of about 70%.

Then, through the human-machine interface 17 of the acoustic resonance diagnostic system 10 for detecting structural degradation, the acoustic resonance diagnostic result can be directly displayed on the user's computer in the form of a graph and stored in a monitoring management clouds platform. Also, through the communication module 13, the on-site leakage inspectors or the experts at the remote end can real-timely grasp the current state of the under-test structure and share the inspection information and historical records.

As disclosed in above embodiments, the present disclosure provides an acoustic resonance diagnostic system and an acoustic resonance diagnostic method for detecting structural degradation capable of real-timely remotely detecting the degradation state of an under-test structure (such as pipe thinning and leakage) using a sound wave signal through contact or non-contact. The dynamic audio capturing module remotely captures the acoustic vibration generated by the under-test structure (such as the pipe wall), senses the change in the stiffness and quality of the under-test structure, and integrates the acoustic vibration to the acoustic resonance diagnostic module through the IoT technology and the cloud computing to build a diagnostic model using a deep learning algorithm, and further synchronically performs leakage recognition, leakage diagnosis and leakage positioning on the under-test sound wave signal to remotely monitor the degradation state.

Furthermore, the acoustic resonance diagnostic module is communication-connected to a plurality of hand-held devices or backend platforms, such that different users can real-timely get a real-time information of the under-test structure (pipe) to help the on-site leakage inspectors interpreting the state of the under-test structure (pipe) more effectively and provide a prompt inspection. Meanwhile, engineers can remotely sense the current state of the structure (pipe) and correctly detect the leakage without visiting the site in person and checking the audio with a stethoscope. Thus, human errors or misjudgments can be reduced, and the operation safety of the under-test structure (pipe) can be assured.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An acoustic resonance diagnostic method for detecting structural degradation, comprising:
building a training model using a deep neural network (DNN);
inputting at least two training acoustic signals to the training model to carry a training;
building a diagnostic model according to a result of the training using a convolutional neural network (CNN);
capturing an under-test sound wave signal from an under-test section of an under-test structure; and
determining a structural degradation state of the under-test section according to the under-test sound wave signal through the diagnostic model.

2. The acoustic resonance diagnostic method for detecting structural degradation according to claim 1, wherein each of the at least two training acoustic signals and the under-test sound wave signal has a time waveform.

3. The acoustic resonance diagnostic method for detecting structural degradation according to claim 2, wherein before building the diagnostic model, the method further comprises a filtering step, comprising:
performing a time domain to frequency domain conversion to convert the time waveform into a frequency-domain waveform; and
capturing a part of the frequency-domain waveform to obtain a frequency band.

4. The acoustic resonance diagnostic method for detecting structural degradation according to claim 3, wherein the diagnostic model comprises:
a plurality of feature labels whose feature values add up to 1.

5. The acoustic resonance diagnostic method for detecting structural degradation according to claim 3, wherein the frequency-domain waveform has a frequency band between 30 Hz˜1600 Hz.

6. The acoustic resonance diagnostic method for detecting structural degradation according to claim 1, wherein the under-test sound wave signal is captured by a sound wave sensing unit which is in contact with or separated from the under-test section.

7. The acoustic resonance diagnostic method for detecting structural degradation according to claim 6, wherein the at least two training acoustic signals are captured from at least two sensing positions of the under-test structure by the sound wave sensing unit.

8. The acoustic resonance diagnostic method for detecting structural degradation according to claim 4, wherein the step of determining the structural degradation state of the under-test section comprises determining the type of the under-test structure according to the feature values and determining whether the under-test section leaks.

9. The acoustic resonance diagnostic method for detecting structural degradation according to claim 1, wherein the step of carrying the training comprises:
performing a normalization treatment on the at least two training acoustic signals, determining whether the at least two training acoustic signals is a transient signal whose waveform changes dramatically or is a steady signal whose waveform is stable and gentle;
selecting a plurality of steady signals from the at least two training acoustic signals, inputting the plurality of steady signals to a deep autoencoder based on a deep convolutional network, extracting a plurality of features and pre-selecting a plurality of feature labels; and
verifying whether the plurality of steady signals that have been treated with a compression process and a decompression process of the deep autoencoder.

10. The acoustic resonance diagnostic method for detecting structural degradation according to claim 1, wherein the step of carrying the training comprises:
inputting a verification sound wave signal to the convolutional neural network of the diagnostic model to be used as a verification data to test whether the diagnostic model can successfully detect a transient state.

11. An acoustic resonance diagnostic system for detecting structural degradation, comprising:
a sound wave sensing unit, used to capture an under-test sound wave signal from an under-test section of an under-test structure;
an acoustic resonance diagnostic module, used to perform the following steps:
building a training model using a deep neural network;
inputting at least two training acoustic signals to the training model to carry a training;
building a diagnostic model according to a result of the training using a convolutional neural network; and
determining a structural degradation state of the under-test section according to the under-test sound wave signal through the diagnostic model; and
a communication module used to signal-connect the sound wave sensing unit to the acoustic resonance diagnostic module.

12. The acoustic resonance diagnostic system for detecting structural degradation according to claim 11, further comprising a signal filter used to obtain a frequency band from a time waveform of each of the at least two training acoustic signals and the under-test sound wave signal.

13. The acoustic resonance diagnostic system for detecting structural degradation according to claim 11, wherein the sound wave sensing unit is in contact with or is separated from the under-test section.

14. The acoustic resonance diagnostic system for detecting structural degradation according to claim 11, wherein the sound wave sensing unit has a global positioning system (GPS).

15. The acoustic resonance diagnostic system for detecting structural degradation according to claim 11, further comprising a hand-held device signal-connected to the acoustic resonance diagnostic module.

16. The acoustic resonance diagnostic system for detecting structural degradation according to claim 11, wherein the training model, comprising:
performing a normalization treatment on the at least two training acoustic signals, determining whether the at least two training acoustic signals is a transient signal whose waveform changes dramatically or is a steady signal whose waveform is stable and gentle;
selecting signals from the at least two training acoustic signals, and inputting the plurality of steady signals to a deep autoencoder based on a deep convolutional network, extracting a plurality of features and pre-selecting a plurality of feature labels; and
verifying whether the plurality of steady signals that have been treated with a compression process and a decompression process of the deep autoencoder.

17. The acoustic resonance diagnostic system for detecting structural degradation according to claim 11, wherein the training model, comprising:
inputting a verification sound wave signal to the convolutional neural network of the diagnostic model to be used as a verification data to test whether the diagnostic model can successfully detect a transient state.
